(19) United States
(12) Patent Application Publication
(10) Pub. No.: US 2025/0341808 A1
(43) Pub. Date: Nov. 6, 2025

(54) DEPRESSIBLE CONTROL BUTTON ASSEMBLY FOR A WEARABLE DEVICE

(71) Applicant: Garmin International, Inc., Olathe, KS (US)

(72) Inventors: Elliot S. Wilder, Olathe, KS (US); Zachary M. Awtry, Jamacia Plain, MA (US); Bryce J. TeBeest, Olathe, KS (US); Ming Xue, Olathe, KS (US); Seth R. Powers, Olathe, KS (US); Matthew L. Russell, Olathe, KS (US); Jason D. Watson, Olathe, KS (US)

(21) Appl. No.: 19/197,865

(22) Filed: May 2, 2025

Related U.S. Application Data
(60) Provisional application No. 63/642,109, filed on May 3, 2024.

(51) Int. Cl. G04G 21/08; G04G 17/08

(52) U.S. Cl. CPC G04G 21/08; G04G 17/08

(57) ABSTRACT

A wearable electronic device comprising a housing. The device additionally includes a force sensor enclosed within an interior of the housing and positioned adjacent to or engaged with an interior surface of the housing. The device further includes a control button assembly engaged with the housing. A proximal end of the control button assembly comprises a contact head. A distal end of the control button assembly comprises a button head that is moveable with respect to the housing. The housing comprises a sidewall, and the sidewall entirely separates the control button assembly from the force sensor. The control button assembly further comprises a snap dome positioned between the contact head and the sidewall of the housing. The snap dome is configured to selectively generate an activation force sufficient to travel through the sidewall and that is detectable by the force sensor.

### CROSS-REFERENCE TO RELATED APPLICATION

The present non-provisional application claims priority benefit to U.S. Provisional Patent Application Ser. No. 63/642,109, filed on May 3, 2024, and entitled “PUSHBUTTON ASSEMBLY FOR A WATCH.” The entirety of the above-identified provisional patent application is hereby incorporated by reference into the present non-provisional application.

### FIELD

Embodiments of the present invention are directed to wearable devices. More particularly, embodiments of the present invention are directed to depressible control button assemblies for wearable electronic devices, such as wristwatches.

### DESCRIPTION OF RELATED ART

Conventional wearable devices, such as wristwatches, often include input/output functionality that allows users to control the devices and receive outputs from the devices. Some conventional wearable devices utilize pushbuttons, which are accessible from the exteriors of the wearable devices, and with which users can interact with the devices. Commonly, a pushbutton will be part of a pushbutton assembly having a snap dome that is attached to a printed circuit board and/or that directly engages a force sensor of the wearable device, with the printed circuit board and/or the force sensor being part of a controller of the wearable device. For example, some pushbuttons having a snap dome are soldered to the printed circuit board, which may cause the snap dome to physically contact and directly engage the force sensor.

Problematically, conventional pushbutton assemblies reduce the ability to seal the interior of wearable devices. For example, the printed circuit boards and force sensors of wearable devices are generally located within the interior of the devices to seal and protect such components from the external environment. However, requiring a pushbutton assembly to directly engage with the printed circuit boards and/or force sensors restricts the ability to seal the interior of the wearable device because the pushbutton itself must also be accessible from the exterior of the wearable device. As such, it would be beneficial if there were an improved pushbutton assembly for a wearable device that provided for accurate, consistent use by a user, while also allowing for the wearable device to maintain the interior of the device in a sealed state.

### SUMMARY

Embodiments of the present invention comprise a wearable electronic device comprising a housing and a controller enclosed within an interior of the housing. The controller comprises a processor and memory. The device additionally includes a force sensor enclosed within an interior of the housing and positioned adjacent to or engaged with an interior surface of the housing. The force sensor is communicatively coupled with the controller. The device further includes a control button assembly engaged with the housing. An exterior of the housing presents a cavity in which at least a portion of the control button assembly is received. A proximal end of the control button assembly comprises a contact head. A distal end of the control button assembly comprises a button head that is moveable with respect to the housing. The control button assembly is configured such that movement of the button head causes a corresponding movement of the contact head. The housing comprises a sidewall, and the sidewall entirely separates the control button assembly from the force sensor. The control button assembly does not extend through the housing into the interior of the housing. The control button assembly further comprises a snap dome positioned between the contact head and the sidewall of the housing. The snap dome is configured to selectively generate an activation force sufficient to travel through the sidewall and that is detectable by the force sensor.

Embodiments of the present invention additionally include a wearable electronic device comprising a housing and a controller enclosed within an interior of the housing. The controller comprises a processor and memory. The device additionally comprises a force sensor enclosed within the interior of the housing and positioned adjacent to or engaged with an interior surface of the housing. The force sensor is communicatively coupled with the controller. The device further comprises a control button assembly engaged with the housing. An exterior of the housing presents a cavity in which at least a portion of the control button assembly is received. A proximal end of the control button assembly comprises a contact head. A distal end of the control button assembly comprises a button head that is moveable with respect to the housing. The control button assembly is configured such that movement of the button head causes a corresponding movement of the contact head. The housing comprises a sidewall, and the sidewall entirely separates the control button assembly from the force sensor, such that the control button assembly is restricted from extending through the housing into the interior of the housing. The control button assembly further comprises a snap dome positioned between the contact head and the sidewall of the housing. The snap dome is configured to selectively generate an activation force sufficient to travel through the sidewall and that is detectable by the force sensor.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a perspective view of a mobile electronic device, in the form of a wearable wristwatch, according to embodiments of the present invention;

FIG. 2 is a schematic depiction of the mobile electronic device, including components thereof, in communication with remote systems over a network;

FIG. 3 is a perspective view of a housing and display device of the mobile electronic device of FIG. 1;

FIG. 4 is a partial cross section of a control button assembly and a force sensor engaged with the housing from the mobile electronic device of FIGS. 1 and 3, with a button head and a contact head of the control button assembly in a neutral position; and

FIG. 5 is another partial cross section of the control button assembly and the force sensor of the mobile electronic device from FIG. 4, with the button head and the contact head of the control button assembly in a depressed position.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

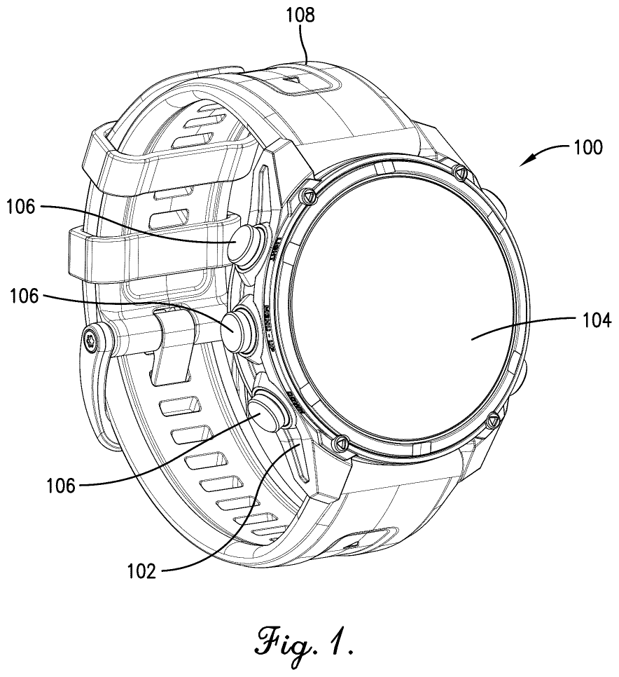

With reference to FIG. 1, embodiments of the present invention are directed to a mobile electronic device 100, which may be in the form of a wearable device such as a wristwatch. The device 100 may comprise a housing 102 or a case configured to substantially enclose various components of the device 100 within an interior of the device 100. The housing 102 may be formed from a lightweight and impact-resistant material such as plastic, nylon, or combinations thereof, for example. However, in other embodiments, the housing 102 may be formed from metal, such a stainless steel, titanium, aluminum, or the like, and/or combinations thereof. The housing 102 may be formed from a conductive material, a non-conductive material, and combinations thereof. The housing 102 may include one or more gaskets, e.g., a seal, to aid the device 100 in being substantially waterproof and/or water resistant. The housing 102 may enclose a battery and/or another power source for powering one or more components of the device 100. The housing 102 may be a singular piece or may include multiple sections.

The device 100 may additionally comprise a display device 104 with a user interface. The display device 104 may include a liquid crystal display (LCD), a thin film transistor (TFT), a light-emitting diode (LED), a light-emitting polymer (LEP), and/or a polymer light-emitting diode (PLED). The display device 104 may be capable of presenting text, graphical, and/or pictorial information. The display device 104 may be backlit such that it may be viewed in the dark or other low-light environments. One example embodiment of the display device 104 is a 100-pixel by 64-pixel film compensated super-twisted nematic display (FSTN) including a bright white light-emitting diode (LED) backlight. The display device 104 may include a transparent lens that covers and/or protects components of the device 100. The display device 104 may be provided with a touch screen to receive input (e.g., data, commands, etc.) from a user. For example, a user may operate the device 100 by touching the touch screen and/or by performing gestures on the screen. In some embodiments, the touch screen may be a capacitive touch screen, a resistive touch screen, an infrared touch screen, combinations thereof, and the like. The device 100 may further include one or more input/output (I/O) devices (e.g., a keypad, buttons, a wireless input device, a thumbwheel input device, etc.). The I/O devices may include one or more audio I/O devices, such as a microphone, speakers, and the like. Additionally, user input may be provided from movement of the housing 102, for example, an inertial sensor(s), e.g., accelerometer, may be used to identify vertical, horizontal, angular movement and/or tapping of the housing 102 or the lens.

In accordance with one or more embodiments of the present disclosure, the user interface of the device 100 may comprise one or more control buttons 106, which may be in the form of pushbuttons. As illustrated in FIG. 1, three control buttons 106 are associated with, e.g., adjacent to, engaged with, and/or extending from, the housing 102. As will be described in more detail below, the control buttons 106 of the present invention may be engaged with the housing 102 via control button assemblies, which are described in more detail below. While FIG. 1 illustrates three control buttons 106 associated with the housing 102, it is understood that the device 100 may include a greater or lesser number of control buttons 106. In one embodiment, each control button 106 is configured to generally control one or more functions of the device 100. Such functionality may be achieved by the user depressing or rotating the control buttons 106, as will be discussed in more detail below.

In some embodiments, the device 100 may include an attachment mechanism 108, e.g., a band or a strap, which enables the device 100 to be attached to and worn by a user. The attachment mechanism 108 may be coupled to and/or integrated with the housing 102 and may be removably secured to the housing 102 via attachment of securing elements to corresponding connecting elements. Some examples of securing elements and/or connecting elements include, but are not limited to, hooks, latches, clamps, snaps, and the like. The attachment mechanism 108 may be made of a lightweight and resilient thermoplastic elastomer and/or a fabric, for example, such that the attachment mechanism 108 may encircle a portion of a user without discomfort while securing the device 100 to the user. The attachment mechanism 108 may be configured to attach to various portions of a user, such as a user's leg, waist, wrist, forearm, upper arm, and/or torso.

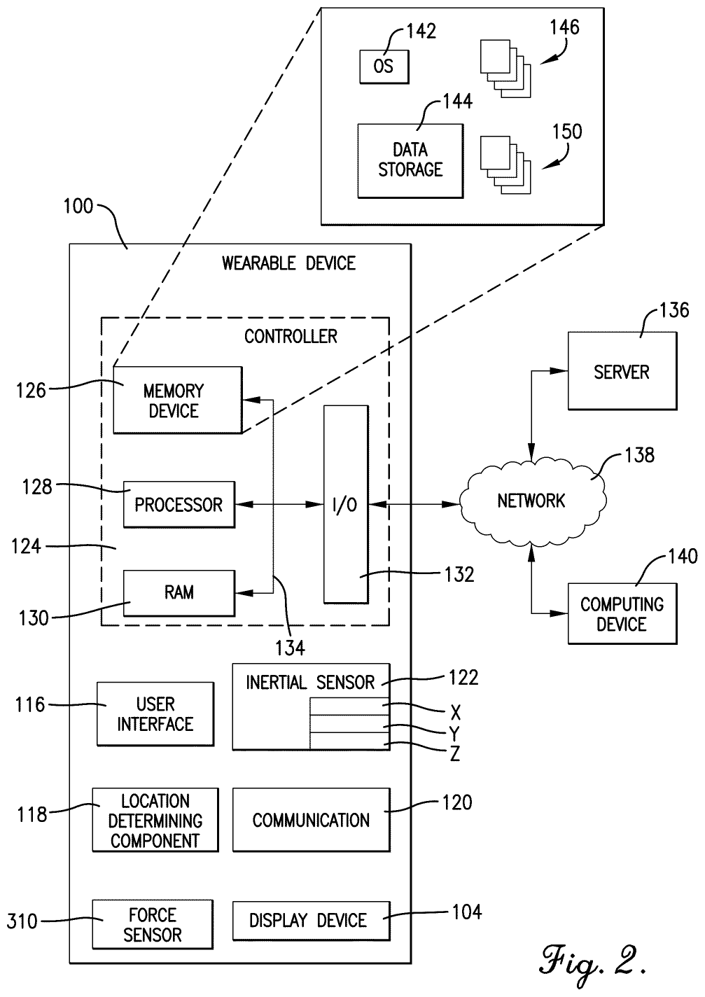

FIG. 2B depicts a system diagram showing components of the device 100 that may be used to carry out certain functions of the device 100, such as those described herein. The device 100 may include a user interface module 116, a location determining component 118 (e.g., a global positioning system (GPS) receiver, assisted-GPS, etc.), a communication module 120, an inertial sensor 122 (e.g., accelerometer, gyroscope, etc.), and a controller 124.

The controller 124 may comprise a control system and/or a processing system that includes a memory device 126, a processor and/or microprocessor (MP) 128, a random-access memory (RAM) 130, and an input/output (I/O) circuitry 132, all of which may be communicatively interconnected via an address/data bus 134. Although the I/O circuitry 132 is depicted in FIG. 2 as a single block, the I/O circuitry 132 may include a number of different types of I/O circuits.

Although the device 100 is generally described herein as a general-use wearable and mobile computing device (e.g., a wristwatch, activity band, etc.), the device 100 may alternatively comprise a cellular phone, a smartphone, a tablet computer, or a mobile personal computer. The device 100 may be a thin-client device or terminal that sends processing functions to a server device 136 via a network 138. Communication via the network 138 may include any combination of wired and wireless technology. For example, the network 138 may include a USB cable between the device 100 and a computing device 140 (e.g., smartphone, tablet, laptop, etc.) to facilitate the bi-directional transfer of data between the device 100 and the computing device 140.

The memory device 126 may include an operating system 142, a data storage device 144, a plurality of software applications 146, and/or a plurality of software routines 150. The operating system 142 of memory device 126 may include any of a plurality of mobile platforms, such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage device 144 of memory device 126 may include application data for the plurality of applications 146, routine data for the plurality of routines 150, and other data necessary to interact with the server 136 through the network 138.

In some embodiments, the components of the controller 124 may be positioned inside the interior of the housing 102 of the device 100. The controller 124 may also include or otherwise be operatively coupled for communication with other data storage mechanisms (e.g., one or more hard disk drives, optical storage drives, solid state storage devices, etc.) that may reside within the device 100 and/or operatively coupled to the network 138 and/or server device 136.

The location determining component 118 generally determines a current geolocation of the device 100 and may process a first electronic signal, such as radio frequency (RF) electronic signals, from a global navigation satellite system (GNSS) such as the global positioning system (GPS) primarily used in the United States, the GLONASS system primarily used in the Soviet Union, or the Galileo system primarily used in Europe. The location determining component 118 may include satellite navigation receivers, processors, controllers, other computing devices, or combinations thereof, and memory. The location determining component 118 may be in electronic communication with an antenna (not shown) that may wirelessly receive an electronic signal from one or more of the previously-mentioned satellite systems and provide the first electronic signal to location determining component 118. The location determining component 118 may process the electronic signal, which includes data and information, from which geographic information such as the current geolocation is determined. The current geolocation may include geographic coordinates, such as the latitude and longitude, of the current geographic location of the device 100. The location determining component 118 may communicate the current geolocation to the processor 128. Generally, the location determining component 118 is capable of determining continuous position, velocity, time, and direction (heading) information.

In some embodiments, the inertial sensor 122 may incorporate one or more accelerometers positioned to determine the acceleration and direction of movement of the device 100. The accelerometer may determine magnitudes of acceleration in an X-axis, a Y-axis, and a Z-axis to measure the acceleration and direction of movement of the device 100 in each respective direction (or plane). It will be appreciated by those of ordinary skill in the art that a three-dimensional vector describing a movement of the device 100 through three-dimensional space can be established by combining the outputs of the X-axis, Y-axis, and Z-axis accelerometers using known methods. Single and multiple axis models of the inertial sensor 122 are capable of detecting magnitude and direction of acceleration as a vector quantity and may be used to sense orientation and/or coordinate acceleration of the user.

Communication module 120 may enable device 100 to communicate with the computing device 140 and/or the server device 136 via any suitable wired or wireless communication protocol independently or using I/O circuitry 132. The wired or wireless network 138 may include a wireless telephony network (e.g., GSM, CDMA, LTE, etc.), one or more standard of the Institute of Electrical and Electronics Engineers (IEEE), such as 802.11 or 802.16 (Wi-Max) standards, Wi-Fi standards promulgated by the Wi-Fi Alliance, Bluetooth standards promulgated by the Bluetooth Special Interest Group, a near field communication standard (e.g., ISO/IEC 18092, standards provided by the NFC Forum, etc.), and so on. Wired communications are also contemplated such as through universal serial bus (USB), Ethernet, serial connections, and so forth.

The device 100 may be configured to communicate via one or more networks 138 with a cellular provider and an Internet provider to receive mobile phone service and various content, respectively. Content may represent a variety of different content, examples of which include, but are not limited to: map data, which may include route information; web pages; services; music; photographs; video; email service; instant messaging; device drivers; real-time and/or historical weather data; instruction updates; and so forth.

The user interface 116 of the device 100 may include a “soft” keyboard that is presented on the display device 104 of the device 100, an external hardware keyboard communicating via a wired or a wireless connection (e.g., a Bluetooth keyboard), and/or an external mouse, or any other suitable user-input device or component. The user interface 116 may also include or communicate with a microphone capable of receiving voice input from a vehicle operator as well as a display device 104 having a touch input. Furthermore, the user interface 116 may include the control buttons 106, which may be in the form of pushbuttons that are described in more detail below.

With reference to the controller 124, it should be understood that controller 124 may include multiple processors and/or microprocessors 128, multiple RAMs 130 and multiple memory devices 126. The processor 128 may be a general or dedicated processing element. The processor 128 may generate, and store in memory device 126, data determined or generated by the device 100. The processor 128 may be further configured to control the display device 104 to present determined data. The controller 124 may implement the RAM 130 and the memory devices 126 as semiconductor memories, magnetically readable memories, and/or optically readable memories, for example. The one or more processors 128 may be adapted and configured to execute any of the plurality of software applications 146 and/or any of the plurality of software routines 150 residing in the memory device 126, in addition to other software applications. One of the plurality of applications 146 may be a client application that may be implemented as a series of machine-readable instructions for performing the various functions associated with implementing the performance monitoring system as well as receiving information at, displaying information on, and transmitting information from the device 100. The client application may function to implement a system wherein the front-end components communicate and cooperate with back-end components as described above. The client application may include machine-readable instructions for implementing the user interface 116 to allow a user to input commands to, and receive information from, the device 100. One of the plurality of applications 146 may be a native web browser, such as Apple's Safari®, Google Android™ mobile web browser, Microsoft Internet Explorer® for Mobile, Opera Mobile™, that may be implemented as a series of machine-readable instructions for receiving, interpreting, and displaying web page information from the server device 136 or other back-end components while also receiving inputs from the device 100. Another application of the plurality of applications 146 may include an embedded web browser that may be implemented as a series of machine-readable instructions for receiving, interpreting, and displaying web page information from the server device 136 or other back-end components within the client application.

The client applications 146 or routines may include an accelerometer routine that determines the acceleration and direction of movements of the device 100, which correlates to the acceleration, direction, and movement of the user. The accelerometer routine may receive and process data from the inertial sensor 122 to determine one or more vectors describing the motion of the user for use with the client application. In some embodiments where the inertial sensor 122 includes an accelerometer having X-axis, Y-axis, and Z-axis accelerometers, the accelerometer routine may combine the data from each accelerometer to establish the vectors describing the motion of the user through three-dimensional space. In some embodiments, the accelerometer routine may use data pertaining to less than three axes.

The client applications 146 or routines 150 may further include a velocity routine that coordinates with the location determining component 118 to determine or obtain velocity and direction information for use with one or more of the plurality of applications, such as the client application, or for use with other routines.

The user may also launch or initiate any other suitable user interface application (e.g., the native web browser, or any other one of the plurality of software applications 146) to access the server device 136 to implement the monitoring process. Additionally, the user may launch the client application from the device 100 to access the server device 136 to implement the monitoring process.

After the above-described data has been gathered or determined by the sensors of the device 100 and stored in memory device 126, the device 100 may transmit information to computing device 140 and server device 136 for storage and additional processing. For example, in embodiments where the device 100 is a thin-client device, the computing device 140 or the server 136 may perform one or more processing functions remotely that may otherwise be performed by the device 100. In such embodiments, the computing device 140 or server 136 may include a number of software applications capable of receiving user information gathered by the sensors. For example, the device 100 may gather information from its sensors as described herein, but instead of using the information locally, the device 100 may send the information to the computing device 140 or the server 136 for remote processing. The computing device 140 or the server 136 may perform the analysis of the gathered user information. For example, the information may be sent to computing device 140 or the server device 136 and include a request for analysis, where the information determined by the computing device 140 or the server device 136 is returned to device 100.

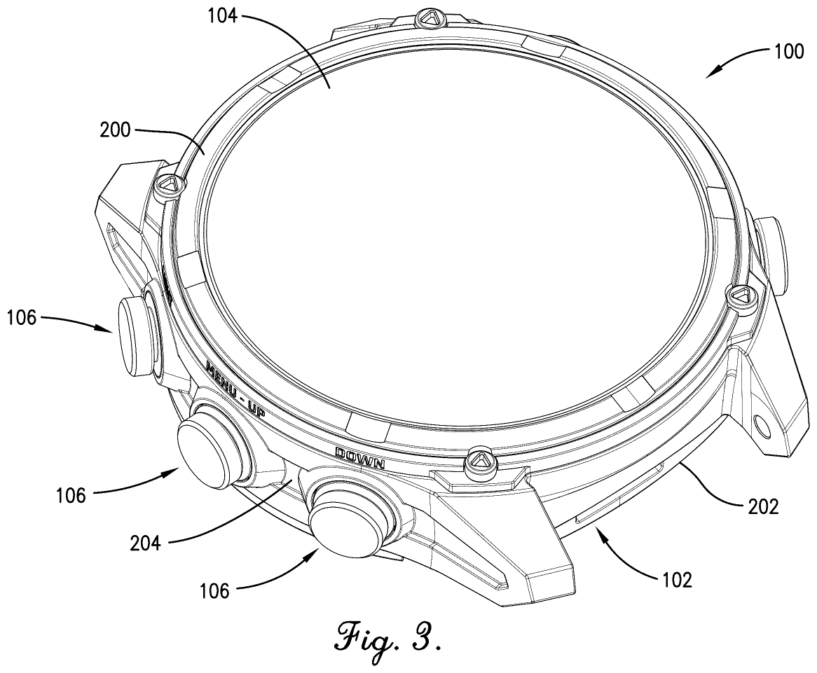

Turning to FIG. 3, embodiments of the present invention are directed to one or more control buttons 106 of the device 100. As shown, the device 100 includes three control buttons 106 on one side of the housing 102. One or more (or all) of the control buttons 106 may be configured as depressible buttons that are accessible to receive a touch from a user's finger or thumb (of the opposite hand) to control functionality of the device 100. For example, each control button 106 may be depressed (or may be rotated) with respect to the housing 102 to control functionality of the device 100.

The housing 102 may comprise an upper wall 200, a lower wall 202, and a perimeter wall 204 extending between peripheries of the upper and lower walls 200, 202. As such, the housing 102 presents an interior space in which various components of the device 100 (e.g., components of the controller 124 illustrated in FIG. 2) may be housed. In some embodiments, the upper wall 200 of the housing 102 may be formed by a bezel with a circular, square, rectangular, or other geometric shape that surrounds the display device 104. The lower wall 202 of the housing 102 may have a circular, square, rectangular, or other geometric shape that generally corresponds with the shape of the upper wall 200.

Beneficially, the control buttons 106 of the device 100 are particularly configured to improve the sealing capabilities of the device 100, such as by allowing the control button 106 to function without the control buttons 106 (or components associated therewith) penetrating through the housing 102 of the device 100. As a result, the configuration of the device 100 results in an improved arrangement of components that enables the device 100 to withstand environmental challenges such as water ingress and pressure into the interior of the housing 102, thereby ensuring the durability and reliability of the device 100, including the control buttons 106, even in demanding conditions. Accordingly, the control buttons 106 according to embodiments of the present invention may be used with a housing 102 of a device 100 that is exposed to water and high-pressure environments, such as a dive watch and similar wearable devices.

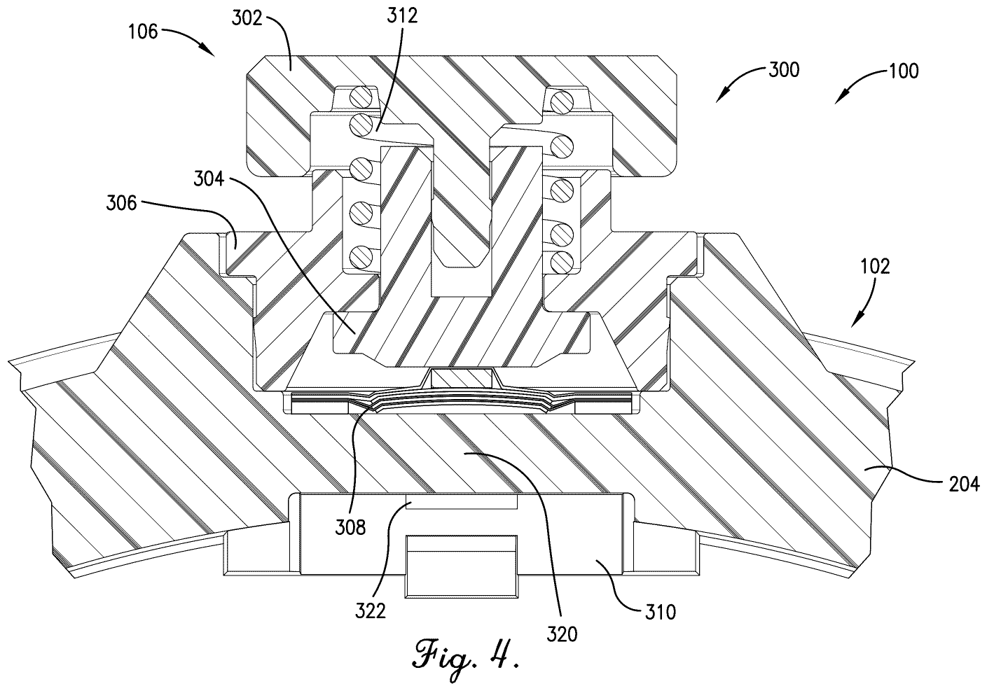

FIG. 4 illustrates one of the control buttons 106 of the device 100 in more detail. As shown, the control button 106 comprises a control button assembly 300, which may be configured as a pushbutton assembly that includes a button head 302, a contact head 304, and a mount 306. As shown, the control button assembly 300 may be positioned on the exterior of the housing 102 of the device 100, with the button head 302 being positioned at a distal end of the control button assembly 300 and the contact head 304 being positioned at a proximal end of the control button assembly 300. In certain embodiments, the control button 106 may additionally comprise or include a snap dome 308 and a force sensor 310. As will be described in more detail below, actuation of the control button assembly 300 may be sensed by the force sensor 310 of the device 100, with the force sensor 310 being positioned and/or enclosed within the interior of the housing 102 of the device 100. As configured, the control button assembly 300 does not extend through the housing 102 into the interior of the housing 102, thereby improving the ability of the device 100 to be sealed from the external environment (e.g., water and pressures).

As illustrated by FIG. 4, the control button assembly 300 may be mounted to the exterior of the housing 102 via the mount 306 that is rigidly engaged with the exterior of the housing 102. In more detail, the exterior of the housing 102 may be formed with a cavity in which the mount 306 is received to, thereby, be rigidly engaged with the housing 102. The cavity may have different shapes depending on the shape of the mount 306; however, in some embodiments, both the cavity and the mount 306 will have a generally circular shape. The mount 306 may have a corresponding circular or cylindrical shape with exterior surfaces configured to engage with interior surfaces of the cavity formed in the housing 102. In some embodiments, the mount 306 will have an outer flange surface that mates with a shelf surface of the cavity. Regardless, the mount 306 will be rigidly engaged with the exterior of the housing 102.

The button head 302 and the contact head 304 of the control button assembly 300 may be movably supported by the mount 306 with respect to the housing 102 of the device 100. For instance, with continuing reference to FIG. 4, the mount 306 may have a cylindrical shape with a hollow interior in which the button head 302 and/or the contact head 304 are movably secured. In more detail, the button head 302 may comprise a circular main body that presents a pushing surface on which a user of the device 100 may press to depress the button head 302. Similarly, the contact head 304 may comprise a circular main body that presents a contact surface that may selectively engage with the snap dome 308 when the user of the device 100 depresses the button head 302. The contact head 304 may additionally include an elongated, cylindrical connection element with a hollow interior that extends from the main body towards the button head 302. Correspondingly, the button head 302 may include an elongated, cylindrical connection element in the form of a projection that extends from the main body towards the contact head 304. As illustrated in FIG. 4, the connection element of the button head 302 will generally be received within the connection element of the contact head 304, such that movement of the button head 302 may cause a corresponding movement of the contact head 304, as will be discussed in more detail below.

The button head 302 and the contact head 304 may be retained within the mount 306 in such a manner that the button head 302 and the contact head 304 are configured to move with respect to the mount 306 and, thus, the housing 102 of the device 100. The contact head 304 may be retained within the mount 306 via the position of its main body being held in place between an interior flange of the mount 306 and the housing 102 of the device 100. The button head 302 may be retained within the mount 306 via a spring element 312 positioned between the main body of the button head 302 and the inner shelf of the mount 306. The spring element 312 may also be configured to bias the button head 302 in a neutral, non-activated/non-depressed position (i.e., the button head 302 is forced away from the housing 102 of the device 100 by the spring element 312).

The snap dome 308, as shown in FIG. 4, is positioned between the contact head 304 and the housing 102 of the device 100. The snap dome 308 may comprise a dome-shaped, bi-stable mechanical element that inverts once a threshold actuation force is applied to its surface (e.g., when a user depresses the button head 302, thereby causing the contact head 304 into contact with the snap dome 308). The snap dome 308 will generally resist movement of the contact head 304 toward the sidewall 320 and against the snap dome 308. However, upon the contact head 304 applying at least the predefined actuation force to the snap dome 308, the snap dome 308 will invert creating a sharp movement activation force, which may be in the form of an impulse force, that is transmitted through the housing 102 and can be sensed by the force sensor 310 positioned within the interior of the housing 102. The portion of the housing 102 that separates the snap dome 308 and the force sensor 310 may be referred to as a sidewall 320. The snap dome 308 may be positioned adjacent to and/or in contact with an exterior surface of the sidewall 320, while the force sensor 310 may be positioned adjacent to and/or in contact with an interior surface of the sidewall 320. Regardless, although the snap dome 308 and the force sensor 310 may be positioned on opposite sides of the sidewall 320, the snap dome 308 and the force sensor 310 may be positioned such that their centers are generally aligned in a radial direction of the device 100. For instance, the center of the force sensor 310 may be aligned with the center of the snap dome 308 (while remaining separated by the sidewall 320). Such alignment of the components enables an accurate conversion of mechanical pressure from the user's pressing of the button head 302, through the snap dome 308, to the force sensor 310 into an electrical signal that the processing element 128 of the controller 124 receives and interprets as a depression of the button head 302.

Turning to the snap dome 308 in more detail, the snap dome 308 may have dome shape and may be positioned adjacent to and/or in engagement with an exterior side of the sidewall 320. The snap dome 308 may be formed from a material and may have a thickness that allows the snap dome 308 to generate a sufficient impulse force once the snap dome 308 inverts such that the inversion (and the corresponding impulse force) may be accurately recognized by the force sensor 310 after passing through the sidewall 320. Inversion of the snap dome 308 results in a sufficient impulse force to ensure the force transfers from the snap dome 308, through the sidewall 320, and to the force sensor 310. For example, the snap dome 308 may be formed from plastic, rubber, or other polymer, as well as various flexible metals. The impulse force may create a deformation of the sidewall 320, which can be sensed by the force sensor 310 due to the force sensor 310 being coupled and/or integrated with the sidewall 320. For instance, the deformation of the sidewall 320 may cause a corresponding and measurable deformation of the force sensor 310 itself.

In some embodiments, the force sensor 310 may be adapted to sense not only the impulse force generated by the inversion of the snap dome 308, but also a sustained deflection of the sidewall 320 caused by the snap dome 308. For instance, when the snap dome 308 is maintained in an inverted state by continued user-applied force on the button head 302, the resulting deformation of the sidewall 320 may likewise be maintained. In these embodiments, the force sensor 310 may be configured to detect and differentiate between a transient impulse indicative of a snap dome 308 inversion and a sustained mechanical deflection corresponding to a prolonged depression of the button head 302. The ability to sense both an initial actuation event and a continued press state may be beneficial for enabling multiple types of user input, such as distinguishing between a single-press command and a press-and-hold command.

In some embodiments, the impulse force generated by the snap dome 308 upon inversion may be utilized for functions beyond or in addition to user input recognition. For example, the pressure exerted by the snap dome 308 against the sidewall 320 may be used to infer environmental conditions such as atmospheric pressure or underwater depth, particularly when calibrated in conjunction with other onboard sensors. The mechanical deformation caused by the snap dome 308 may also generate detectable acoustic or vibrational signatures that can propagate through the housing 102 and be captured by sensors-such as piezoelectric elements or MEMS microphones-positioned within the device 100. These signals may be interpreted to characterize ambient acoustic environments or serve as an input for voice activation or underwater communication systems.

Because, in certain embodiments, the snap dome 308 is dome shaped, the snap dome may be formed with a convex side or surface and a concave side or surface. In some embodiments, the snap dome 308 will be positioned with the convex side facing outward from the sidewall 320 towards the contact head 304 of the control button assembly 300, as shown in FIG. 4. As a result, when a user pushes downward on the button head 302 (towards the sidewall 320), the contact head 304 will be forced downward (towards the sidewall 320) towards and/or into contact with the convex side of the snap dome 308. Upon the force applied by the user being sufficient for the contact head 304 to apply the predefined actuation force against the snap dome 308, the snap dome 308 will invert and generate and send an impulse force through the sidewall 320, which can be sensed by the force sensor 310. The impulse force generated by the inversion of the snap dome 308 will also provide a tactile feedback up through the contact head 304 and the button head 302 that can be felt by the user. As such, the snap dome 308 is configured to function as tactile detent.

In alternative embodiments, the snap dome 308 will be positioned with the concave side facing outward from the sidewall 320 towards the contact head 304 of the control button assembly 300. As a result, when a user pushes downward on the button head 302 (towards the sidewall 320), the contact head 304 will be forced downward (towards the sidewall 320) towards and/or into contact with the concave side of the snap dome 308. Upon the force applied by the user being sufficient for the contact head 304 to apply the predefined actuation force against the snap dome 308, the snap dome 308 will invert and generate and send an impulse force through the sidewall 320, which can be sensed by the force sensor 310.

Turning to the force sensor 310 in more detail, the force sensor 310 may comprise a strain gauge sensor, such as a Micro-Electro-Mechanical Systems (MEMS) strain gauge sensor. The force sensor 310 may be positioned adjacent to and/or in contact with an interior side of the sidewall 320. Specifically, the force sensor 310 may be mounted securely to the interior of the sidewall 320 of the housing 102, or to another internal structure of the device 100, such as a printed circuit board (PCB) positioned within the interior of the housing 102. As such, upon the snap dome 308 generating the impulse force, which transmits through the sidewall 320, the force sensor 310 is configured to sense such impulse force. To ensure that the sidewall 320 is configured to transmit the impulse force, the sidewall 320 may be formed from a material conducive to transmitting a mechanical force (e.g., via deformation), such as various types of plastic or metal. In addition, the sidewall 320 may have a thickness from 0.25 to 10 mm, from 0.50 to 5 mm, from 0.75 to 2 mm, or about 1.0 mm.

The force sensor 310 may be communicatively coupled with the controller 124 (e.g., the processor 128), such that the force sensor 310 can provide an indication of the sensed impulse force to the controller 124. As a result, the controller 124 can determine from the information received from the force sensor 310 that the control button assembly 300 has been actuated by a user from the neutral position to the depressed position.

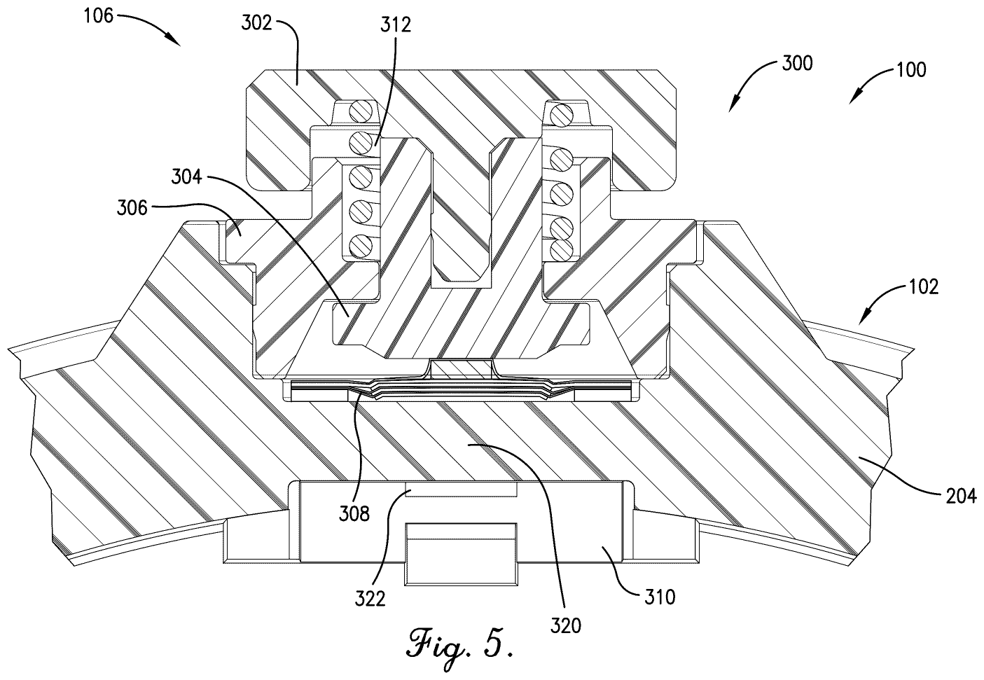

In more detail, the control button assembly 300 of the device 100 described above can be actuated by a user to control one or more functions of the device 100. For example, the user may provide an instruction to the device 100 to perform a function by actuating the button head 302 of the control button assembly 300. As noted above, the button head 302 and the contact head 304 are configured to actuate with respect to the mount 306 and the housing 102 of the device 100. For instance, the user may depress the button head 302, such that the button head 302 shifts from the neutral position (see, e.g., FIG. 4) towards the sidewall 320 of the housing 102 to the depressed position (see, e.g., FIG. 5). Because the control button assembly 300 is configured such that movement of the button head 302 will cause a corresponding movement of the contact head 304, depression of the button head 302 causes a corresponding shifting of the contact head 304 from the neutral position (see, e.g., FIG. 4) towards the sidewall 320 of the housing 102 to the depressed position (see, e.g., FIG. 5).

In the depressed position, the contact head 304 will contact the snap dome 308 and impart a force against the snap dome 308. Upon the force of the contact head 304 being greater than or equal to the threshold actuation force, the snap dome 308 will invert and generate a mechanical impulse force that can pass through the sidewall 320 of the housing 102 to be received by the force sensor 310. The precise threshold actuation force required to invert the snap dome 308 can be set to minimize or prevent inadvertent activation by the user, which ensures that the force sensor 310 only senses deliberate actions by the user to depress the button head 302.

Upon the button head 302 being deliberately depressed by the user to activate a requisite function of the device 100, the force sensor 310, which is communicably coupled with the controller 124, will provide an indication of the control button assembly 300 being actuated and will thereby control the requisite functionality of the device 100. As such, the snap dome 308 facilitates an indirect transfer of force from user interaction with the button head 302 of the control button assembly 300 to the force sensor 310 through the sidewall 320 of the housing 102. Notably, the impulse force generated by the inversion of the snap dome 308 will also provide a tactile feedback to the user, which is indicative of the control button assembly 300 being properly actuated to cause the requisite functionality of the device 100. For example, the snap dome 308 may provide improved tactile feedback to the user, indicating a successful actuation of the button head 302 through a noticeable “click” sensation, a feature that is particularly valuable in conditions where visual or auditory confirmation may be limited. As a result, use of the snap dome 308 in the control button assembly 300 improves tactile feel of successful button head 302 presses and sets a mechanical threshold that must be exceeded to activate or engage the force sensor 310 for each button head 302 press.

As described above, the force sensor 310 is configured to sense a deformation of the sidewall 320 and/or the force sensor 310 itself. Upon a successful button head 302 press, the force sensor 310 converts the mechanical force caused by the inversion of the snap dome 308 into an electrical signal (i.e., a control signal) that can be transmitted to the processing element 128 of the controller 124. The controller 124 can, thus, identify control signals received from the force sensor 310 as successful button head 302 press events. The sidewall 320 acts as a mechanical barrier for the force sensor 310 within the interior of the housing 102 and sufficient force resulting from an inversion of the snap dome 308 on the exterior of the sidewall 320 enables the force sensor 310 to accurately recognize a deliberate depression of the button head 302 of the control button assembly 300. Such a configuration may result in the force sensor 310 not recognizing low-force inadvertent interactions with the button head 302 to minimize false positives, which is particularly helpful in environments where the device 100 may be subjected to incidental contact or pressure changes. Use of the improved control button 106 in a dive watch or an outdoor watch may improve the robustness and reliability of such watches.

The integration of the snap dome 308 in the control button assembly 300 may also provide advantages in terms of power management and signal integrity. The controller 124 may be configured to keep certain components of the device 100, such as the force sensor 310, in a low-power state until a force exceeding the snap dome's 308 threshold actuation force is applied to conserve the device's 100 battery life. Furthermore, a distinct, high-amplitude impulse force generated by inversion of the snap dome 308 may enhance the signal-to-noise ratio (SNR) for the force sensor 310, enabling a processor to more accurately differentiate between intentional button presses causing the snap dome to invert and ambient pressure variations or incidental forces.

In some embodiments, the device 100 may incorporate power-saving techniques to address concerns related to continuous sensing and monitoring by the force sensor 310. More specifically, the control button assembly 300 may include a piezoelectric activation element 322, such as a piezo disk, configured to generate an electrical signal upon the application of mechanical stress—e.g., when the user presses the button head 302. The piezoelectric effect may be leveraged such that pressing the button head 302 results in deformation of the piezo disk, thereby producing a voltage spike or transient signal. This generated signal may be used as a triggering mechanism to activate or “wake” one or more sensing or processing components of the device 100, including the force sensor 310 and/or associated controller 124. By employing the piezoelectric activation element 322 to serve as a low-power activation trigger, the device 100 and/or certain of its components can remain in an ultra-low-power idle or sleep state during periods of inactivity, thereby significantly reducing overall power consumption. The piezoelectric activation element 322 may function independently of the main sensing circuitry and may not require constant power to remain operational, which further enhances battery life. Once the piezoelectric signal is detected, the device 100 may promptly activate the force sensor 310 to monitor the mechanical response of the sidewall 320 (e.g., deformation caused by inversion of the snap dome 308).

Upon the user releasing the button head 302, the spring element 312 will bias the button head 302 (and thus the contact head 304) back to the neutral position. Although the above description illustrates how embodiments of the present invention can be used to allow a user to control functionality of the device 100 by depressing the button head 302, it should be understood that in other embodiments, the user may also control functionality of the device 100 by rotating the button head 302 (and thus the contact head 304), such that the button head 302 may operate as a crown.

The control button 106 according to embodiments of the present invention, as described above, is particularly configured to allow the interior of the device 100 to be sealed from the external environment. For example, because the control button assembly 300, including the snap dome 308, does not directly engage the force sensor 310 but is separated from the force sensor by the sidewall 320, the interior of the housing 102 can remain sealed from the external environment. Stated differently, the control button assembly 300 is configured such that it does not extend through the housing 102 (e.g., through the sidewall 320) into the interior of the housing 102.

Because the control button assembly 300 is partially positioned within the cavity on the exterior of the housing 102 of the device 100, and because the housing 102 (and particularly the sidewall 320) separates and encloses the force sensor 310 and other internal components of the device 100 in an internal cavity of the device's 100 housing 102, embodiments of the present invention result in an improved arrangement of components that enables the device 100 to withstand environmental challenges such as water ingress and pressure, ensuring the durability and reliability of the control button 106 in demanding conditions. Accordingly, the control button 106 may be used within a device 100 housing 102 that is exposed to water and high-pressure environments, such as a dive watch and similar wearable devices. Nevertheless, it is to be understood that the techniques and improvements described herein may be implemented in any portable, wearable or mounted electronic device having control buttons, such as a device utilized in marine applications that may be subject to water (e.g., a watch, a mobile phone, a hand-held portable computer, a tablet computer, a personal digital assistant, a multimedia device, a media player, a game device, or any combination thereof).

In some embodiments, the device 100 may utilize non-contact sensing methods to measure the deflection of the sidewall 320, thereby enabling further miniaturization and spatial optimization of internal components. Rather than relying on a physically coupled strain gauge or similar force sensor 310, the device 100 may employ optical-based sensing techniques such as laser displacement sensors, photodiodes, or total internal reflection (TIR) methods to detect mechanical deflection of the sidewall 320 resulting from user actuation of the control button assembly 300. These non-contact approaches may operate by detecting subtle changes in light position, intensity, or angle caused by deformation of the sidewall 320 when the snap dome 308 inverts. For example, a laser-based displacement sensor may emit a beam toward the inner surface of the sidewall 320 and measure the reflected signal to determine deflection with high precision. In other embodiments, a photodiode array may be positioned to receive redirected or scattered light resulting from movement of a reflective or translucent coating applied to the sidewall 320, with the variation in light intensity across the array indicating the magnitude of deflection. Similarly, a total internal reflection (TIR) sensor may detect changes in the critical angle of light traveling along a transparent substrate adhered to or integrated within the sidewall 320, with the deformation altering the path of internal reflections and resulting in a measurable change in output signal. Additional implementations may include interferometric sensors, which detect minute changes in optical path length due to sidewall movement, or fiber optic bend sensors that respond to changes in curvature or strain in proximity to the snap dome 308. Such a configuration allows components may be positioned physically away from the sidewall 320, thereby freeing up valuable space within the housing 102 of the device 100.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A wearable electronic device comprising:
a housing;
a controller enclosed within an interior of the housing, wherein the controller comprises a processor and memory;
a force sensor enclosed within the interior of the housing and positioned adjacent to or engaged with an interior surface of the housing, wherein the force sensor is communicatively coupled with the controller and configured to generate control signals for use by the controller to control functionality of the device; and
a control button assembly engaged with the housing, wherein an exterior of the housing presents a cavity in which at least a portion of the control button assembly is received,
wherein a proximal end of the control button assembly comprises a contact head,
wherein a distal end of the control button assembly comprises a button head that is moveable with respect to the housing, and wherein the control button assembly is configured such that movement of the button head causes a corresponding movement of the contact head,
wherein the housing comprises a sidewall, and wherein the sidewall entirely separates the control button assembly from the force sensor, wherein the control button assembly does not extend through the housing into the interior of the housing,
wherein the control button assembly further comprises a snap dome positioned between the contact head and the sidewall of the housing, wherein the snap dome is configured to selectively generate an activation force sufficient to travel through the sidewall and that is detectable by the force sensor.

2. The wearable electronic device of claim 1, wherein the button head is configured to be actuated towards the sidewall of the housing.

3. The wearable electronic device of claim 2, wherein when the button head is actuated towards the sidewall of the housing, a position of the contact head is correspondingly shifted towards the snap dome.

4. The wearable electronic device of claim 3, wherein the snap dome is configured to generate the activation force upon the contact head of the control button assembly contacting the snap dome and applying a threshold actuation force to the snap dome, and wherein the activation force of the snap dome is a mechanical impulse force.

5. The wearable electronic device of claim 4, wherein upon the threshold actuation force being applied to the snap dome by the button head, the snap dome is configured to provide tactile feedback.

6. The wearable electronic device of claim 4, wherein the snap dome comprises a concave surface, and wherein the concave surface faces the sidewall of the housing.

7. The wearable electronic device of claim 4, wherein the control button assembly further includes a spring that biases the contact head in a direction away from the snap dome.

8. The wearable electronic device of claim 1, wherein the control button assembly further comprises a mount rigidly secured to the housing within the cavity, wherein the button head is configured to actuate with respect to the mount and to the housing.

9. The wearable electronic device of claim 1, wherein the force sensor comprises a micro-electromechanical systems (MEMS) sensor.

10. The wearable electronic device of claim 1, wherein the force sensor comprises a strain gauge sensor.

11. The wearable electronic device of claim 10, wherein the strain gauge sensor comprises a piezoelectric sensor.

12. The wearable electronic device of claim 1, wherein the wearable electronic device is a watch.

13. The wearable electronic device of claim 12, wherein the watch is a dive watch configured to operate underwater.

14. The wearable electronic device of claim 13, wherein the dive watch is water resistant such that the dive watch is configured to restrict water from entering the interior of the housing when the dive watch is underwater.

15. The wearable electronic device of claim 1, wherein the housing, including the sidewall, is formed from plastic or metal.

16. The wearable electronic device of claim 15, wherein the sidewall has a thickness from 0.5 to 5 mm.

17. A wearable electronic device comprising:
a housing;
a controller enclosed within an interior of the housing, wherein the controller comprises a processor and memory;
a force sensor enclosed within the interior of the housing and positioned adjacent to or engaged with an interior surface of the housing, wherein the force sensor is communicatively coupled with the controller and configured to generate control signals for use by the controller to control functionality of the device; and
a control button assembly engaged with the housing, wherein an exterior of the housing presents a cavity in which at least a portion of the control button assembly is received,
wherein a proximal end of the control button assembly comprises a contact head,
wherein a distal end of the control button assembly comprises a button head that is moveable with respect to the housing, and wherein the control button assembly is configured such that movement of the button head causes a corresponding movement of the contact head,
wherein the housing comprises a sidewall, and wherein the sidewall entirely separates the control button assembly from the force sensor, such that the control button assembly is restricted from extending through the housing into the interior of the housing,
wherein the control button assembly further comprises a snap dome positioned between the contact head and the sidewall of the housing, wherein the snap dome is configured to selectively generate an activation force sufficient to travel through the sidewall and that is detectable by the force sensor.

18. The wearable electronic device of claim 17, wherein when the button head is actuated towards the sidewall of the housing, a position of the contact head is correspondingly shifted towards the snap dome, wherein the snap dome is configured to generate the activation force upon the contact head of the control button assembly contacting the snap dome and applying a threshold force to the snap dome, and wherein the activation force is an impulse force.

19. The wearable electronic device of claim 17, wherein the wearable electronic device is a watch.

20. A wearable electronic device comprising:
a housing;
a controller enclosed within an interior of the housing, wherein the controller comprises a processor and memory;
a force sensor enclosed within the interior of the housing and positioned adjacent to or engaged with an interior surface of the housing, wherein the force sensor is communicatively coupled with the controller and configured to generate control signals for use by the controller to control functionality of the device; and
a control button assembly engaged with the housing, wherein an exterior of the housing presents a cavity in which at least a portion of the control button assembly is received,
wherein a proximal end of the control button assembly comprises a contact head,
wherein a distal end of the control button assembly comprises a button head that is moveable with respect to the housing, and wherein the control button assembly is configured such that movement of the button head causes a corresponding movement of the contact head,
wherein the housing comprises a sidewall, and wherein the sidewall entirely separates the control button assembly from the force sensor, such that the control button assembly is restricted from extending through the housing into the interior of the housing,
wherein the control button assembly further comprises a snap dome positioned between the contact head and the sidewall of the housing, wherein the snap dome is configured to selectively generate an activation force sufficient to travel through the sidewall and that is detectable by the force sensor,
wherein the control button assembly further comprises a piezoelectric activation element configured to generate an electrical signal in response to user actuation of the button head, and wherein the force sensor is configured to wake from a low-power state in response to receiving the electrical signal to measure the activation force generated by the snap dome.
